(19) United States
(12) Patent Application Publication
(10) Pub. No.: US 2015/0362066 A1
(43) Pub. Date: Dec. 17, 2015

(54) CONTROL DEVICE FOR VEHICULAR DRIVE DEVICE

(71) Applicant: AISIN AW CO., LTD., Aichi (JP)

(72) Inventors: Masashi KITO, Anjo (JP); Yuichi SEKI, Okazaki (JP); Yoichi TAJIMA, Anjo (JP); Yuichiro UMEMOTO, Okazaki (JP); Hiroki SHINTANI, Tokai (JP)

(73) Assignee: AISIN AW CO., LTD., Aichi-ken (JP)

(21) Appl. No.: 14/764,827

(22) PCT Filed: Mar. 28, 2014
(86) PCT No.: PCT/JP2014/059334

§ 371 Date: Jul. 30, 2015

(30) Foreign Application Priority Data
Mar. 29, 2013 (JP) 2013-073829

(51) Int. Cl. F16H 61/04; F16H 59/74

(52) U.S. Cl. CPC F16H 61/04; F16H 59/74; F16H 2059/746

(57) ABSTRACT

A control device, wherein, after the ignition is turned on or the vehicular power supply is turned on and before a first change from the parking range to the travel range occurs, the control device supplies oil to a piston hydraulic pressure chamber of the hydraulic pressure type engagement element in a manner such that air in the piston hydraulic pressure chamber of the hydraulic pressure type engagement element is discharged but a torque capacity does not exceed zero.

### TECHNICAL FIELD

The present disclosure relates to a control device for a vehicular drive device.

### BACKGROUND ART

A hydraulic pressure control device for an automatic transmission is known, which discharges air mixed in a hydraulic pressure circuit by forcibly supplying a hydraulic pressure with respect to a friction engagement element that has to be disengaged at a current shift speed while not changing a shift speed (for example, refer to Patent Document 1).

### RELATED ART DOCUMENT

### Patent Document

Patent Document 1: Japanese Patent Application Publication No. 2002-243029 (JP 2002-243029 A)

### SUMMARY OF THE INVENTION

### Problem to be Solved by the Invention

However, in a configuration described in the aforementioned Patent Document 1, there has been a problem that the responsiveness when establishing an initial gear stage (i.e., at a first change from a parking range to a travel range after an ignition is turned on or a vehicular power supply is turned on) is not improved because a hydraulic pressure is forcibly supplied with respect to the friction engagement element that has to be disengaged at the current shift speed.

Here, it is an object of the present disclosure to provide a control device for a vehicular drive device that is capable of improving the responsiveness when establishing an initial gear stage.

### Means for Solving the Problem

According to an aspect of the present disclosure, a control device for a vehicular drive device is provided, which includes a hydraulic pressure type engagement element that is provided between a drive source and drive wheels, the hydraulic pressure type engagement element being in a disengaged state when an ignition is turned on or a vehicular power supply is turned on and caused to transition to an engaged state when a parking range is changed to a travel range, wherein, after the ignition is turned on or the vehicular power supply is turned on and before a first change from the parking range to the travel range occurs, the control device supplies oil to a piston hydraulic pressure chamber of the hydraulic pressure type engagement element in a manner such that air in the piston hydraulic pressure chamber of the hydraulic pressure type engagement element is discharged but a torque capacity does not exceed zero.

### Effects of the Invention

According to the present disclosure, a control device for a vehicular drive device that is capable of improving the responsiveness when establishing an initial gear stage can be provided.

### BRIEF DESCRIPTION OF THE DRAWINGS

FIG. 1 is a skeleton diagram showing an example of a vehicular drive device 1.

FIG. 2 is a table showing a relationship between shift speeds in a transmission 20 shown in FIG. 1 and each clutch (C-1, etc.) and each brake (B-1, etc.).

FIG. 3 shows an example of a hydraulic pressure circuit 60 relating to the transmission 20 and a controller 90.

FIG. 4 is a flowchart showing an example of control for a first hydraulic pressure clutch C-1 executed by the controller 90.

FIG. 5 is an exemplary drawing of FIG. 4 and a timing chart showing an example of a change manner of a piston hydraulic pressure of the first hydraulic pressure clutch C-1 after an ignition is turned on.

FIG. 6 is a flowchart showing another example of control for the first hydraulic pressure clutch C-1 executed by the controller 90.

FIG. 7 is an exemplary drawing of FIG. 6 and a timing chart showing an example of a change manner of a piston hydraulic pressure of the first hydraulic pressure clutch C-1 after the ignition is turned on.

### MODES FOR CARRYING OUT THE INVENTION

Hereinafter, respective embodiments will be described in detail with reference to the accompanying drawings.

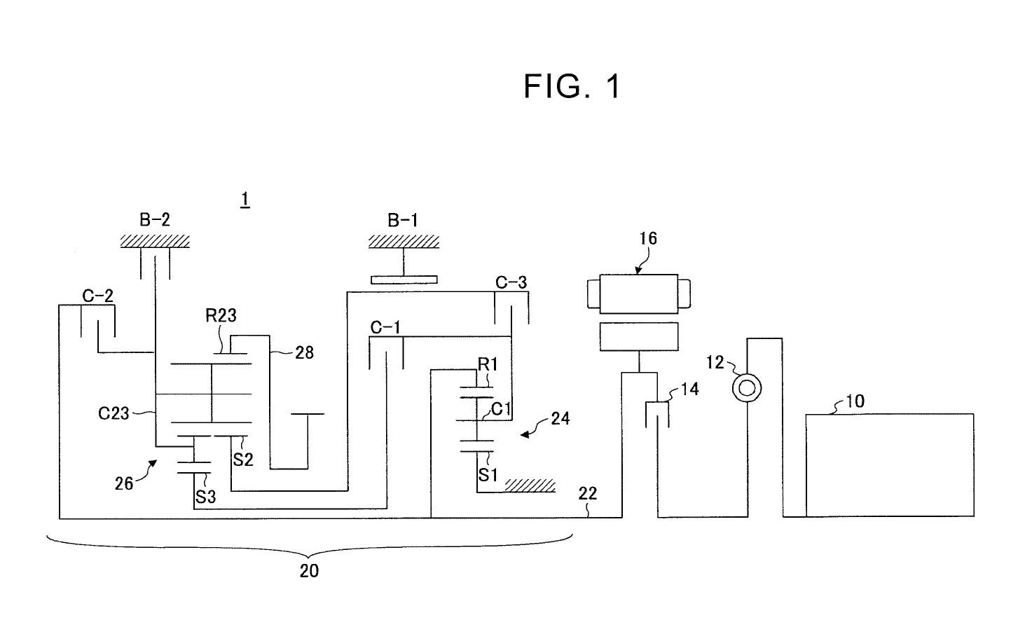

FIG. 1 is a skeleton diagram showing an example of a vehicular drive device 1.

The vehicular drive device 1 includes an engine 10, an electric motor 16, and a transmission 20. An output shaft of the engine 10 is connected with an input shaft 22 through a damper 12 and an engine disconnection clutch 14

The engine disconnection clutch 14 is formed by a hydraulic pressure clutch. The configuration of the hydraulic pressure clutch itself may be arbitrary. For example, the hydraulic pressure clutch may be configured to generate a frictional force by moving a piston by a hydraulic pressure (a piston hydraulic pressure) inside a piston hydraulic pressure chamber to press a friction element. The engine disconnection clutch 14 connects the input shaft 22 with the engine 10 when the engine disconnection clutch 14 is in an engaged state and disconnects the engine 10 from the input shaft 22 when the engine disconnection clutch 14 is in a disengaged state. The electric motor 16 is provided so as to supply rotational torque to the input shaft 22. The configuration of the electric motor 16 may be arbitrary. The electric motor 16 may be for example a three-phase permanent-magnet motor. The transmission 20 changes a rotational speed of the input shaft 22 and transmits the resultant rotational speed to an output shaft 28. The configuration of the transmission 20 may be arbitrary as long as a hydraulic pressure clutch is provided. The hydraulic pressure clutch of the transmission 20 may be configured to generate a frictional force by moving a piston by a hydraulic pressure (a piston hydraulic pressure) inside a piston hydraulic pressure chamber to press a friction element.

In the example shown in FIG. 1, the transmission 20 includes a first hydraulic pressure clutch C-1, a second hydraulic pressure clutch C-2, a third hydraulic pressure clutch C-3, a first brake B-1, and a second brake B-2. In addition, the transmission 20 includes a planetary gear mechanism 24 and a Ravigneaux type gear mechanism 26. The Ravigneaux type gear mechanism 26 is provided with a gear row which is common to a carrier C23 and a ring gear R23 of a single planetary gear and a double-pinion planetary gear.

The input shaft 22 is connected with a ring gear R1 of the planetary gear mechanism 24. The output shaft 28 is connected with the ring gear R23 of the Ravigneaux type gear mechanism 26. In addition, a sun gear S1 of the planetary gear mechanism 24 is fixed.

The first hydraulic pressure clutch C-1 is provided between a carrier C1 of the planetary gear mechanism 24 and a sun gear S3 of the Ravigneaux type gear mechanism 26. The first hydraulic pressure clutch C-1 connects the carrier C1 with the sun gear S3 when the first hydraulic pressure clutch C-1 is in an engaged state and disconnects the carrier C1 from the sun gear S3 when the first hydraulic pressure clutch C-1 is in a disengaged state.

The second hydraulic pressure clutch C-2 is provided between the input shaft 22 and a carrier 23 of the Ravigneaux type gear mechanism 26. The second hydraulic pressure clutch C-2 connects the input shaft 22 with the carrier C23 when the second hydraulic pressure clutch C-2 is in an engaged state and disconnects the input shaft 22 from the carrier C23 when the second hydraulic pressure clutch C-2 is in a disengaged state.

The third hydraulic pressure clutch C-3 is provided between the carrier C1 of the planetary gear mechanism 24 and a sun gear S2 of the Ravigneaux type gear mechanism 26. The third hydraulic pressure clutch C-3 connects the carrier C1 with the sun gear S2 when the third hydraulic pressure clutch C-3 is in an engaged state and disconnects the carrier C1 from the sun gear S2 when the third hydraulic pressure clutch C-3 is in a disengaged state.

The first brake B-1 is provided with respect to the sun gear S2 of the Ravigneaux type gear mechanism 26. The first brake B-1 stops rotation of the sun gear S2 when operating.

The second brake B-2 is provided with respect to the carrier C23 of the Ravigneaux type gear mechanism 26. The second brake B-2 stops rotation of the carrier C23 when operating.

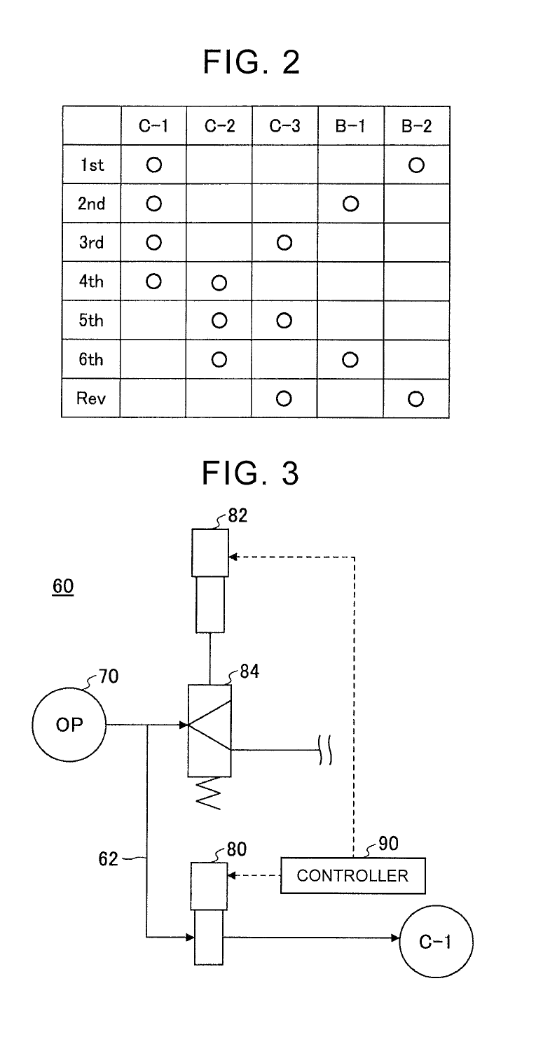

FIG. 2 is a table showing a relationship between shift speeds in the transmission 20 shown in FIG. 1 and each clutch (C-1, etc.) and each brake (B-1, etc.). In FIG. 2, for the first hydraulic pressure clutch C-1, the second hydraulic pressure clutch C-2, and the third hydraulic pressure clutch C-3, a symbol ◯ indicates an engaged state. For the first brake B-1 and the second brake B-2, the symbol ◯ indicates an operating state. For example, when a first gear stage is established, the first hydraulic pressure clutch C-1 becomes in the engaged state and the second brake B-2 becomes in the operating state. In addition, in a case in which a one-way clutch is utilized as a modification example of the configuration shown in FIG. 1, only the first hydraulic pressure clutch C-1 becomes in the engaged state when the first gear stage is established. In such a case, the function of the second brake B-2 is realized by the one-way clutch.

FIG. 3 shows an example of a hydraulic pressure circuit 60 relating to the transmission 20 and a controller 90. In FIG. 3, for its convenience, only the first hydraulic pressure clutch C-1 is shown. However, other hydraulic clutches (C-2, etc.) and respective brakes (B-1, etc.) may be connected in parallel with a hydraulic pressure line 62 via a solenoid.

The hydraulic pressure circuit 60 includes the hydraulic pressure line 62, a linear solenoid 82 and a regulator valve 84 for controlling the hydraulic pressure (line pressure) of the hydraulic pressure line 62, and a linear solenoid 80 for controlling a hydraulic pressure that is supplied to the first hydraulic pressure clutch C-1.

Here, as shown in FIG. 3, the hydraulic pressure circuit 60 is not provided with a manual valve that is interlocked with a switch operation on a shift lever that is operated by a driver. The manual valve generally blocks an oil supply to the first hydraulic pressure clutch C-1 when a P-range is established, and allows the oil supply to the first hydraulic pressure clutch C-1 when a travel range (1^{st}, 2^{nd}, etc.) is established.

The controller 90 may be formed for example by a microcomputer. The controller 90 controls the linear solenoid 80, etc. The controller 90 is connected with an ignition switch, an oil temperature sensor, etc. In addition, the controller 90 is connected with a shift position sensor that detects a position of the shift lever.

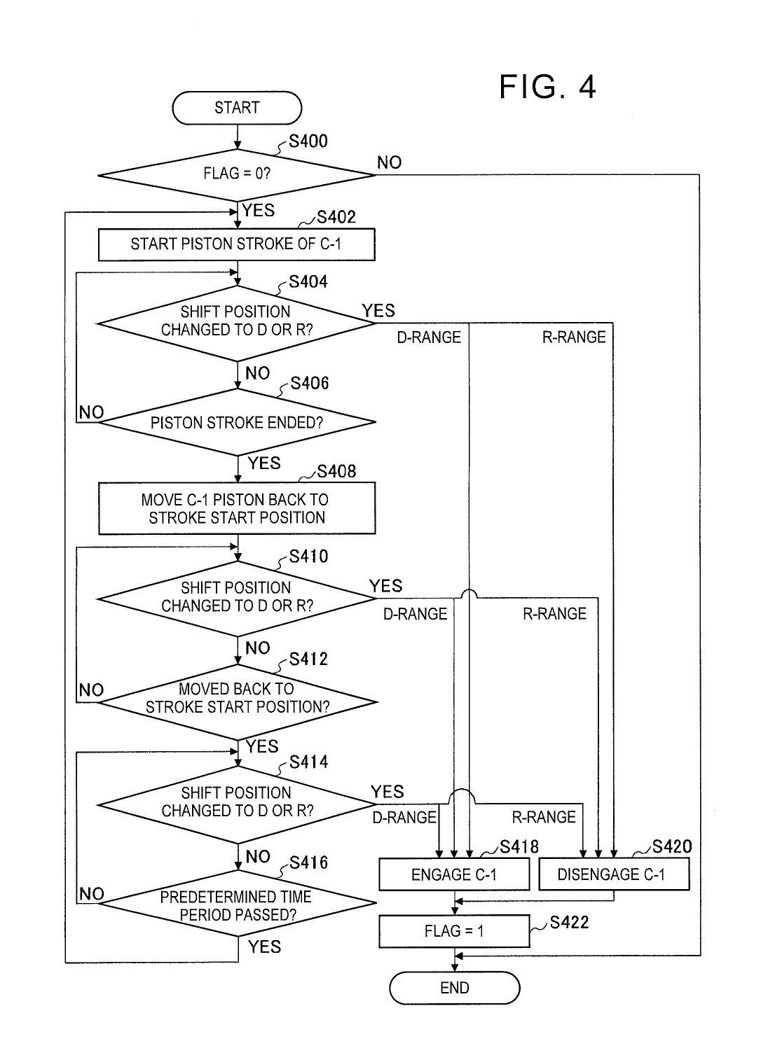

FIG. 4 is a flowchart showing an example of control for the first hydraulic pressure clutch C-1 (linear solenoid 80) executed by the controller 90. The process shown in FIG. 4 is activated when the ignition switch is turned on. Note that the shift position is the P-range when the ignition is tuned on. Hereinafter, it is supposed that the engine disconnection clutch 14 is brought into an engaged state immediately after the ignition switch is turned on.

At Step 400, it is determined whether a predetermined flag is an initial value 0. Once the flag is set to “1,” the value “1” is maintained until the flag is reset to the initial value “0” when the ignition switch is turned off. The value of the flag is 0 immediately after the ignition switch is turned on. In a case in which the flag is the initial value 0, the procedure proceeds to Step 402. In other cases, the procedure terminates.

At Step 402, a piston stroke of the first hydraulic pressure clutch C-1 is started. That is, by controlling the linear solenoid 80, a piston hydraulic pressure chamber of the first hydraulic pressure clutch C-1 is allowed to communicate with the hydraulic pressure line 62 and oil starts to be supplied to the piston hydraulic pressure chamber of the first hydraulic pressure clutch C-1. The start of the piston stroke of the first hydraulic pressure clutch C-1 may be executed as quickly as possible after the ignition switch is turned on.

At Step 404, it is determined based on information from the shift position sensor whether the shift position has been changed (switched) from the P-range to a D-range (drive range) or a R-range (reverse range). That is, it is determined whether a change from the P-range after the ignition was turned on to an initial travel range (travel range for start) has occurred. Naturally, a change in the shift position from the P-range to the D-range or the R-range includes a case in which the P-range is changed to the D-range or the R-range through a N-range (neutral range), which also applies to a case in which a time period in the N-range is long. The following applies to these cases in the same manner. In a case in which the shift position has been changed from the P-range to the D-range, the procedure proceeds to Step 418. In a case in which the shift position has been changed from the P-range to the R-range, the procedure proceeds to Step 420. In other cases (in a case in which the P-range is maintained), the procedure proceeds to Step 406.

At Step 406, it is determined whether the piston stroke of the first hydraulic pressure clutch C-1 has ended. The end position of the piston stroke of the first hydraulic pressure clutch C-1 is arbitrary. However, the end position is preferably set to a position at which air in the piston hydraulic pressure chamber of the first hydraulic pressure clutch C-1 (and in the hydraulic pressure line 62) is discharged but a torque capacity does not exceed zero (i.e., any gear stage is not established). For example, the end position of the piston stroke of the first hydraulic pressure clutch C-1 may be set to a position at which the piston starts to touch a friction element or immediately before the piston touches a friction element. Whether the piston stroke of the first hydraulic pressure clutch C-1 has ended may be determined by referring to a map using an oil temperature and a stroke time period as parameters. In such a case, for example, the stroke time period (time required to move to the end position of the piston stroke) in relation to the oil temperature may be defined in the map based on tests and analysis results, etc. In a case in which the piston stroke of the first hydraulic pressure clutch C-1 has ended, the procedure proceeds to Step 408. In a case in which the piston stroke of the first hydraulic pressure clutch C-1 has not ended, the procedure returns to Step 404. In such a case, after a predetermined processing cycle, the process from Step 404 is executed again.

At Step 408, the piston of the first hydraulic pressure clutch C-1 is moved back to a stroke start position. That is, by controlling the linear solenoid 80, the piston hydraulic pressure chamber of the first hydraulic pressure clutch C-1 is caused to communicate with a drain side (not shown) to drain oil from the piston hydraulic pressure chamber of the first hydraulic pressure clutch C-1.

At Step 410, it is determined based on information from the shift position sensor whether the shift position has changed from the P-range to the D-range or the R range. In a case in which the shift position has changed from the P-range to the D-range, the procedure proceeds to Step 418. In a case in which the shift position has changed from the P-range to R-range, the procedure proceeds to Step 420. In other cases, the procedure proceeds to Step S412.

At Step 412, it is determined whether the piston of the first hydraulic pressure clutch C-1 has moved back to the stroke start position. Whether the piston stroke of the first hydraulic pressure clutch C-1 has moved back to the stroke start position may be determined by referring to a map using the oil temperature and the stroke time period as parameters. In such a case, for example, the stroke time period (time required to move from the end position of the piston stroke to the stroke start position) in relation to the oil temperature may be defined in the map based on tests and analysis results, etc. In a case in which the piston of the first hydraulic pressure clutch C-1 has moved back to the stroke start position, the procedure proceeds to Step 414. In a case in which the piston of the first hydraulic pressure clutch C-1 has not moved back to the stroke start position, the procedure returns to Step 410. In such a case, after a predetermined processing cycle, the process from Step 410 is executed again.

At Step 414, it is determined based on information from the shift position sensor whether the shift position has changed from the P-range to the D-range or the R range. In a case in which the shift position has changed from the P-range to the D-range, the procedure proceeds to Step 418. In a case in which the shift position has changed from the P-range to R-range, the procedure proceeds to Step 420. In other cases, the procedure proceeds to Step 416.

At Step 416, it is determined whether a predetermined time period T1 has passed. The predetermined time period T1 corresponds to a time at which air is accumulated in the piston hydraulic pressure chamber of the first hydraulic pressure clutch C-1 (and in the hydraulic pressure line 62) to an amount which could affect the responsiveness of the first hydraulic pressure clutch CA and may be adapted based on test results, etc. In a case in which the predetermined time period T1 has passed, the procedure returns to Step 402. In such a case, after a predetermined processing cycle, the process from Step 402 is executed again.

At Step 418, the first hydraulic pressure clutch C-1 is caused to be engaged (an engaged state is established). That is, by controlling the linear solenoid 80, the piston hydraulic pressure chamber of the first hydraulic pressure clutch C-1 is allowed to communicate with the hydraulic pressure line 62 to generate a predetermined hydraulic pressure in the piston hydraulic pressure chamber of the first hydraulic pressure clutch C-1. In such an event, in order to reduce a shock at a time of engaging, the first hydraulic pressure clutch C-1 is preferably caused to transition to the engaged state through a slip state. That is, after performing slip control, the engaged state is established.

At Step 420, the first hydraulic pressure clutch C-1 is caused to be disengaged (a disengaged state is established). In a case in which the piston of the first hydraulic pressure clutch C-1 is being moved to the stroke start position at the moment (refer to Step 408), on-going control may be continued. In a case in which the piston of the first hydraulic pressure clutch C-1 is positioned at the stroke start position at the moment (refer to Step 416), the state may be maintained (in such a case, particular control is not executed). In a case in which the piston of the first hydraulic pressure clutch C-1 is being moved to the end position of the piston stroke at the moment (refer to Step 402), on-going control is stopped and switched to control that disengages the first hydraulic pressure clutch C-1.

At Step 422, a flag is set to “1.”

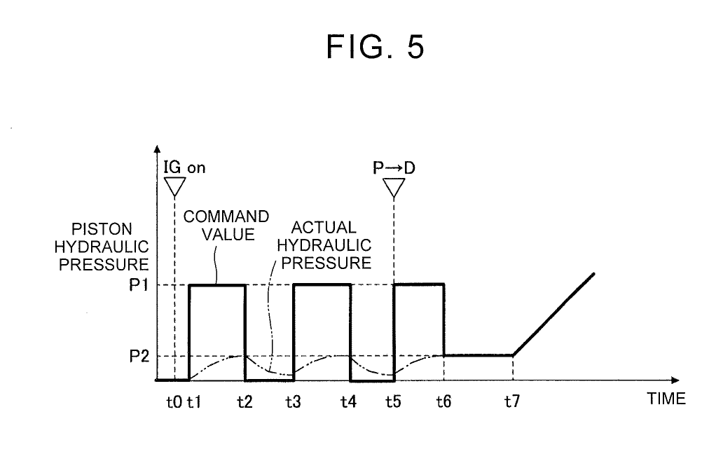

FIG. 5 is an exemplary drawing of FIG. 4 and a timing chart showing an example of a change manner of a piston hydraulic pressure of the first hydraulic pressure clutch C-1 after the ignition switch is turned on (at a time of an ignition-on). FIG. 5 shows a command value of the piston hydraulic pressure by solid line and an actual value (actual hydraulic pressure) of the piston hydraulic pressure by dashed-dotted line.

In the example shown in FIG. 5, the ignition switch is turned on at time t0. Immediately, at time t1, the command value of the piston hydraulic pressure goes up from 0 to a predetermined first value P1. Thereby, the piston of the first hydraulic pressure clutch C-1 starts to stroke (refer to Step 402 in FIG. 4). Along with the foregoing movement, the actual hydraulic pressure gradually increases, as shown in FIG. 5. Thereafter, the command value of the piston hydraulic pressure maintains to be the predetermined first value P1 up to time t2. At time t2, a positive determination is given at Step 406 in FIG. 4 (it is determined that the piston stroke of the first hydraulic pressure clutch C-1 has ended). At this moment, the actual hydraulic pressure has increased up to an actual hydraulic pressure P2. Note that, with the actual hydraulic pressure P2, the torque capacity by the first hydraulic pressure clutch C-1 does not exceed 0. At time t2, the command value of the piston hydraulic pressure is caused to decrease to 0. Thereby, the piston of the first hydraulic pressure clutch C-1 is moved back to the stroke start position (refer to Step 408 and Step 412 in FIG. 4). Along with the foregoing movement, the actual hydraulic pressure gradually decreases, as shown in FIG. 5. Thereafter, at time t3 at which the predetermined time period T1 (refer to Step 416 in FIG. 4) has passed, the actual hydraulic pressure becomes substantially 0, i.e., in a state in which air can easily enter the piston hydraulic pressure chamber of the first hydraulic pressure clutch C-1 (and the hydraulic pressure line 62). Then, at time t3, the command value of the piston hydraulic pressure goes up from 0 to the predetermined first value P1. Thereby, the piston of the first hydraulic pressure clutch C-1 starts to stroke (refer to Step 402 in FIG. 4). Along with the foregoing movement, the actual hydraulic pressure gradually increases, as shown in FIG. 5. Thereafter, the command value of the piston hydraulic pressure is maintained to be the predetermined first value P1 up to time t4. At time t4, a positive determination is given at Step 406 in FIG. 4 (it is determined that the piston stroke of the first hydraulic pressure clutch C-1 has ended). At this moment, the actual hydraulic pressure has increased up to the actual hydraulic pressure value P2. Note that a time period from time t3 to time t4 may be the same as a time period from time t1 to time t2. However, considering that it is the second stroke (considering that air is less likely to be accumulated compared to the first time), the time period from time t3 to time t4 may be set shorter than the time period from time t1 to time t2.

Thereafter, when the shift position is changed from the P-range to the D-range at time t5 (positive determination at Step 410 or Step 414 in FIG. 4), the command value of the piston hydraulic pressure goes up from 0 to the predetermined first value P1 at time t5. Thereby, as shown in FIG. 5, the actual hydraulic pressure gradually increases. Thereafter, the command value of the piston hydraulic pressure maintains to be the predetermined first value P1 up to time t6 and is caused to decrease to a predetermined second value P2 at time t6. Thereafter, the command value of the piston hydraulic pressure maintains to be the predetermined second value P2 up to time t7. At this event, as shown in FIG. 5, the actual hydraulic pressure substantially follows the command value P2 of the piston hydraulic pressure. The command value of the piston hydraulic pressure increases at a predetermined inclination from the predetermined second value P2 subsequent to time t7. At this moment, as shown in FIG. 5, the actual hydraulic pressure increases by substantially following the command value of the piston hydraulic pressure. Thereby, the first hydraulic pressure clutch C-1 establishes an engaged state through a slip state.

As described above, in the examples shown in FIGS. 4 and 5, after the ignition switch is turned on and before the shift position is changed from the P-range to the D-range, the piston of the first hydraulic pressure clutch C-1 strokes and the oil is supplied, in advance, to the piston hydraulic pressure chamber of the first hydraulic pressure clutch C-1. Thereby, after the ignition switch is turned on and before the shift position is changed from the P-range to the D-range, it is possible to discharge (reduce) air in the piston hydraulic pressure of the first hydraulic pressure clutch C-1 (and the hydraulic pressure line 62). Consequently, after the ignition switch is turned on, when the shift position is changed from the P-range to the D-range, the first hydraulic pressure clutch C-1 is engaged. At such a moment, it is possible to improve the responsiveness of the first hydraulic pressure clutch C-1.

In addition, in the examples shown in FIGS. 4 and 5, after the oil has been supplied, in advance, to the piston hydraulic pressure chamber of the first hydraulic pressure clutch C-1, the supplied oil is discharged. Consequently, in a case in which the shift position is changed from the P-range to the R-range during a period during which the oil is discharged (t2 to t3, t4 to t5 in the example shown in FIG. 5), it is possible to disengage the first hydraulic pressure clutch C-1 with a high responsiveness.

Note that, in the example shown in FIG. 5, the command value of the piston hydraulic pressure when supplying in advance the oil to the first hydraulic pressure clutch C-1 and the initial value of the command value of the piston hydraulic pressure when changing from the P-range to the D-range are the same value of P1. Thereby, it is possible to finish the advance oil supply with a short time period. However, the command value of the piston hydraulic pressure when supplying in advance the oil to the first hydraulic pressure clutch C-1 may be a value smaller than the initial value P1 of the command value of the piston hydraulic pressure when changing from the P-range to the D-range. In addition, in the example shown in FIG. 5, the command value of the piston hydraulic pressure when supplying in advance the oil to the first hydraulic pressure clutch C-1 is constant at P1. However, it may be changeable in a range smaller than P1.

In addition, in the example shown in FIG. 5, the shift position is changed from the P-range to the D-range at time t5 at which the oil in the piston hydraulic pressure chamber of the first hydraulic pressure clutch C-1 is discharged. However, the shift position may be changed from the P-range to the D-range in a different timing. For example, in a case in which the shift position is changed from the P-range to the D-range (positive determination at Step 404 in FIG. 4) while the oil is supplied to the piston hydraulic pressure chamber of the first hydraulic pressure clutch C-1 such as during the time period from time t1 to time t2 and during the time period from time t3 to time t4 (or when the oil supply has completed), the command value at the moment may be taken over and transition to an engaged state may be performed. For example, in a case in which the shift position is changed from the P-range to the D-range at time t3′ which is between time t3 and time t4, the predetermined first value P1 is maintained by a time period acquired by subtracting the time period of time t3 to t3′ from the time period of time t5 to time t6, and thereafter the command value may be outputted in a command value pattern subsequent to time t6. In such a case, the responsiveness of the first hydraulic pressure clutch C-1 may be further improved because control of the advance oil supply is taken over.

In addition, in the examples shown in FIGS. 4 and 5, the control for the first hydraulic pressure clutch C-1 is described. However, the control may be performed in the same manner with respect to the third hydraulic pressure clutch C-3 and/or the second brake B-2. As shown in FIG. 2, the control for the third hydraulic pressure clutch C-3 is to engage the third hydraulic pressure clutch C-3 when the shift position is changed from the P-range to the R-range, and the control for the second brake B-2 is to engage the second brake B-2 when the shift position is changed from the P-range to the D-range or R-range. For example, in a case in which the control is performed in the same manner with respect to the third hydraulic pressure clutch C-3, it is possible to improve the responsiveness of the third hydraulic pressure clutch C-3 when the shift position is changed from the P-range to the R-range after the ignition switch is turned on.

In addition, in the examples shown in FIGS. 4 and 5, it is supposed that the engine disconnection clutch 14 is brought into an engaged state immediately after the ignition switch is turned on (before the shift position is changed from the P-range to the D-range or the R-range). However, the functions of the first hydraulic pressure clutch C-1 and the engine disconnection clutch 14 may be replaced with each other. That is, the first hydraulic pressure clutch C-1 may be configured to be brought into an engaged state immediately after the ignition switch is turned on, and the engine disconnection clutch 14 may be configured to be engaged when the shift position is changed from the P-range to the D-range after the ignition switch is turned on. In such a case, the control shown in FIG. 4 may be performed with respect to the engine disconnection clutch 14 in place of the first hydraulic pressure clutch C-1.

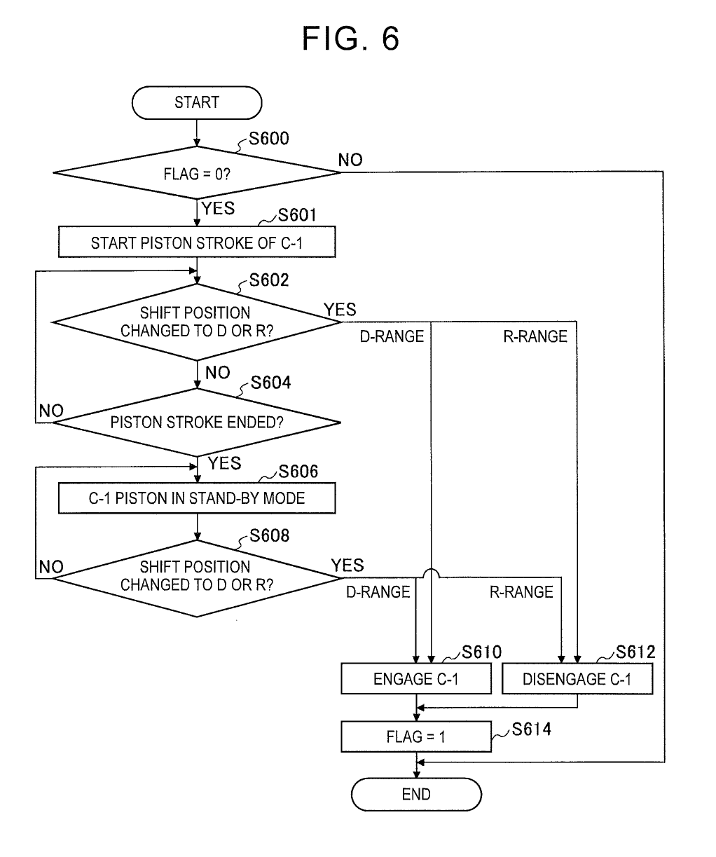

FIG. 6 is a flowchart showing another example of control for the first hydraulic pressure clutch C-1 (linear solenoid 80) executed by the controller 90. The process shown in FIG. 6 is activated when the ignition switch is turned on. Note that the shift position is the P-range when the ignition switch is turned on. Note that, hereinafter, it is supposed that the engine disconnection clutch 14 is brought into an engaged state immediately after the ignition switch is turned on.

In the process shown in FIG. 6, the processes of Step 600, Step 601, Step 602, Step 604, Step 610, Step 612, and Step 614 may be the same as the processes of Step 400, Step 402, Step 404, Step 406, Step 418, Step 420, and Step 422 shown in FIG. 4, respectively. Consequently, the explanation is not given for these processes. However, in a case in which the shift position has been changed from the P-range to the D-range at Step 602, the procedure proceeds to Step 610. In a case in which the shift position has been changed from the P-range to the R-range at Step 602, the procedure proceeds to Step 612. In other cases, the procedure proceeds to Step 604. In addition, in a case in which a positive determination is given at Step 604, the process proceeds to Step 606.

At Step 606, the first hydraulic pressure clutch C-1 is brought into a stand-by state. Specifically, by controlling the linear solenoid 80, the piston hydraulic pressure chamber of the first hydraulic pressure clutch C-1 is allowed to communicate with the hydraulic pressure line 62 and oil continues to be supplied to the piston hydraulic pressure chamber of the first hydraulic pressure clutch C-1. Note that the oil supply in such a case is executed in a manner such that the piston stroke (i.e., the end position of the piston stroke) after the oil has been supplied, in advance, to the first hydraulic pressure clutch C-1 at Step 600 is maintained That is, the oil supply manner at Step 606 is different from the oil supply manner at Step 600 and is a supply manner in which the position of the piston is maintained. However, it is not necessary that the end position of the piston stroke is completely maintained. The oil supply manner at Step 606 may be a manner in which the piston stroke is slightly moved back to the stroke start position.

At Step 608, it is determined based on the information from the shift position sensor whether the shift position has been changed from the P-range to the D-range or the R-range. In a case in which the shift position has been changed from the P-range to the D-range, the procedure proceeds to Step 610. In a case in which the shift position has been changed from the P-range to the R-range, the procedure proceeds to Step 612. In other cases, the procedure proceeds to Step 606.

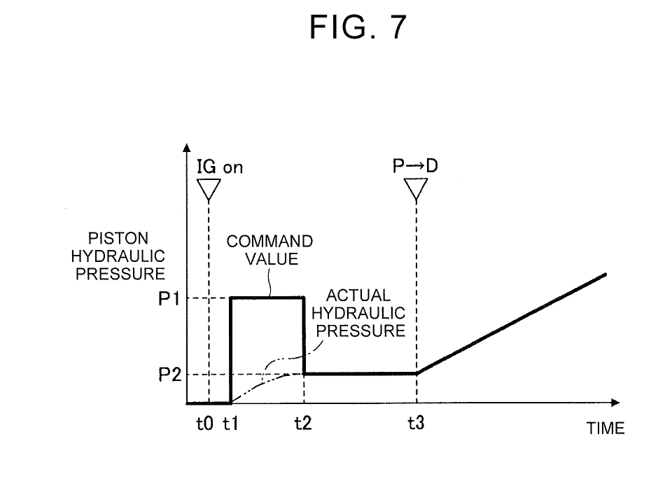

FIG. 7 is an exemplary drawing of FIG. 6 and a timing chart showing an example of a change manner of the piston hydraulic pressure of the first hydraulic pressure clutch C-1 after the ignition switch is turned on (after an ignition-on). In FIG. 7, the command value of the piston hydraulic pressure is indicated by solid line and an actual value (actual hydraulic pressure) of the piston hydraulic pressure is indicated by dashed-dotted line.

In the example shown in FIG. 7, the ignition switch is turned on at time t0. Immediately, at time t1, the command value of the piston hydraulic pressure goes up from 0 to a predetermined first value P1. Thereby, the piston of the first hydraulic pressure clutch C-1 starts to stroke (refer to Step 600 in FIG. 6). Along with the foregoing movement, the actual hydraulic pressure gradually increases, as shown in FIG. 7. Thereafter, the command value of the piston hydraulic pressure maintains to be the predetermined first value P1 up to time t2. At time t2, a positive determination is given at Step 604 in FIG. 6 (it is determined that the piston stroke of the first hydraulic pressure clutch C-1 has ended). At this moment, the actual hydraulic pressure has increased up to an actual hydraulic pressure P2. Note that, with the actual hydraulic pressure P2, the torque capacity by the first hydraulic pressure clutch C-1 does not exceed 0. At time t2, the command value of the piston hydraulic pressure is caused to decrease to a predetermined second value P2. Thereafter, the command value of the piston hydraulic pressure is maintained to be the predetermined second value P2 up to time t3. Thereby, as shown in FIG. 7, the actual hydraulic pressure substantially follows the command value P2 of the piston hydraulic pressure.

Thereafter, in a case in which the shift position is changed from the P-range to the D-range at time t3 (positive determination at Step 608 in FIG. 6), the command value of the piston hydraulic pressure increases at a predetermined inclination from the predetermined second value P2 at time t3. Thereby, as shown in FIG. 7, the actual hydraulic pressure increases by substantially following the command value of the piston hydraulic pressure. Thereby, the first hydraulic pressure clutch C-1 establishes an engaged state through a slip state.

As described above, in the examples shown in FIGS. 6 and 7, after the ignition switch is turned on and before the shift position is changed from the P-range to the D-range, the piston of the first hydraulic pressure clutch C-1 strokes and the oil is supplied, in advance, to the piston hydraulic pressure chamber of the first hydraulic pressure clutch C-1. Thereby, after the ignition switch is turned on and before the shift position is changed from the P-range to the D-range, it is possible to discharge air in the piston hydraulic pressure chamber of the first hydraulic pressure clutch C-1 (and in the hydraulic pressure line 62). Consequently, after the ignition switch is turned on, when the shift position is changed from the P-range to the D-range, the first hydraulic pressure clutch C-1 is engaged. At such a moment, it is possible to improve the responsiveness of the first hydraulic pressure clutch C-1.

In addition, in the example shown in FIG. 7, the command value of the piston hydraulic pressure when supplying in advance the oil to the piston hydraulic pressure chamber of the first hydraulic pressure clutch C-1 is constant at P1. However, it may be changeable in a range smaller than P1.

In addition, in the example shown in FIG. 7, the shift position is changed from the P-range to the D-range while the command value of the piston hydraulic pressure is maintained to be the predetermined second value P2. However, the shift position may be changed from the P-range to the D-range at a different timing. For example, in a case in which the shift position is changed from the P-range to the D-range during the time period from time t1 to time t2 (positive determination at Step 602 in FIG. 6), the command value at the moment may be taken over and the transition to an engaged state may be performed. In such a case, the responsiveness of the first hydraulic pressure clutch C-1 is further improved.

In addition, in the examples of FIGS. 6 and 7, the control for the first hydraulic pressure clutch C-1 is explained. However, the control may be performed in the same manner for the third hydraulic pressure clutch C-3 and/or the second brake B-2. As shown in FIG. 2, the control for the third hydraulic pressure clutch C-3 is to engage the third hydraulic pressure clutch C-3 when the shift position is changed from the P-range to the R-range, and the control for the second brake B-2 is to engage the second brake B-2 when the shift position is changed from the P-range to the D-range or R-range.

In addition, in the examples shown in FIGS. 6 and 7, it is supposed that the engine disconnection clutch 14 is brought into an engaged state immediately after the ignition switch is turned on. However, the functions of the first hydraulic pressure clutch C-1 and the engine disconnection clutch 14 may be replaced with each other. That is, the first hydraulic pressure clutch C-1 may be configured to be brought into an engaged state immediately after the ignition switch is turned on, and the engine disconnection clutch 14 may be configured to be engaged when the shift position is changed from the P-range to the D-range after the ignition switch is turned on. In such a case, the control shown in FIG. 6 may be performed with respect to the engine disconnection clutch 14 in place of the first hydraulic pressure clutch C-1.

Although various embodiments have been discussed in detail above, the present invention is not limited to specific embodiments, and a variety of modifications and changes may be made without departing from the scope described in the claims. In addition, all or a plurality of the constituent elements according to the embodiments discussed above may be combined with each other.

For example, in the embodiments discussed above, the vehicular drive device 1 of a hybrid vehicle is exemplified. However, a vehicular drive device of a vehicle having only an engine as a drive source, or a vehicular drive device of an electric vehicle having only an electric motor as a drive source may be applied in the same manner. In case of the vehicular drive device of a vehicle having only an engine as the drive source, for example, in the configuration shown in FIG. 1, the electric motor 16 and the engine disconnection clutch 14 may not be provided and the input shaft 22 may be configured to be connected with the engine 10 through the damper 12. In addition, in case of the vehicular drive device of an electric vehicle, for example, in the configuration shown in FIG. 1, the engine 10, the damper 12, and the engine disconnection clutch 14 may not be provided. Note that, in case of the electric vehicle, the usage “the ignition switch is turned on” in the above explanation may be replaced with “the electric power switch is turned on (an operation to switch an electric motor from off to on).”

Although various embodiments have been discussed in detail above, the present invention is not limited to specific embodiments, and a variety of modifications and changes may be made without departing from the scope described in the claims. In addition, all or a plurality of the constituent elements according to the embodiments discussed above may be combined with each other.

The present international application claims priority from the Japanese application No. 2013-073829 filed on Mar. 29, 2013, all the contents of which is incorporated herein by reference.

For the aforementioned embodiments, the following is further disclosed.

(1)

A control device (90) for a vehicular drive device (1) includes a hydraulic pressure type engagement element (C-1) that is provided between a drive source (10, 16) and drive wheels, the hydraulic pressure type engagement element (C-1) being in an disengaged state when an ignition is turned on or a vehicular power supply is turned on and caused to transition to an engaged state when a parking range is changed to a travel range, wherein, after the ignition is turned on or the vehicular power supply is turned on and before a first change from the parking range to the travel range occurs, the control device supplies oil to a piston hydraulic pressure chamber of the hydraulic pressure type engagement element (C-1) in a manner such that air in the piston hydraulic pressure chamber of the hydraulic pressure type engagement element (C-1) is discharged but a torque capacity does not exceed zero.

According to the configuration described in (1), after the ignition is turned on or the vehicular power supply is turned on and before the first change from the parking range to the travel range occurs, the oil is supplied, in advance, to the piston hydraulic pressure chamber of the hydraulic pressure type engagement element (C-1). Thereby, it is possible to discharge (reduce) air in the piston hydraulic pressure chamber of the hydraulic pressure type engagement element (C-1) (and in the hydraulic pressure line 62) after the ignition is turned on or the vehicular power supply is turned on and before the shift position is changed from the parking range to the travel range. Consequently, after the ignition is turned on or the vehicular power supply is turned on, in a case in which the shift position is changed from the parking range to the travel range, the hydraulic pressure type engagement element (C-1) is engaged. At such a moment, it is possible to improve the responsiveness of the hydraulic pressure type engagement element (C-1).

(2)

In the control device (90) according to (1), after the oil has been supplied to the piston hydraulic pressure chamber and until the first change from the parking range to the travel range occurs, the control device (90) repeats discharging the supplied oil from the piston hydraulic pressure chamber and supplying the oil to the piston hydraulic pressure chamber.

According to the configuration described in (2), in a case in which the shift position is changed from the parking range to an R range during a period during which the oil is discharged, it is possible to disengage the hydraulic pressure type engagement element (C-1) with a high responsiveness. In addition, in a case in which the shift position is changed from the parking range to the R range during a period during which oil is supplied, it is possible to engage the hydraulic pressure type engagement element (C-1) with a high responsiveness.

(3)

In the control device (90) according to (2), a magnitude of a hydraulic pressure command value when the oil is supplied to the piston hydraulic pressure chamber is the same as a magnitude of an initial value of the hydraulic pressure command value when the first change from the parking range to the travel change has occurred.

According to the configuration described in (3), it is possible to finish the oil supply to the piston hydraulic pressure chamber of the hydraulic pressure type engagement element (C-1) with a short time period.

(4)

In the control device (90) according to (1), after the oil has been supplied to the piston hydraulic pressure chamber and until the first change from the parking range to the travel range occurs, the control device (90) continues supplying the oil to the piston hydraulic pressure chamber.

According to the configuration described in (4), an oil supply state is continued. Therefore, in a case in which the shift position is changed from the parking range to the travel range after or during the oil supply, it is possible to engage the hydraulic pressure type engagement element (C-1) with a high responsiveness.

(5)

In the control device (90) according to (4), continuing supplying the oil to the piston hydraulic pressure chamber is executed in a manner such that a piston stroke after the oil has been supplied to the piston hydraulic pressure chamber is maintained.

According to the configuration described in (5), the piston stroke after the oil has been supplied to the piston hydraulic pressure chamber is maintained Therefore, in a case in which the shift position is changed from the parking range to the travel range in a maintained state, it is possible to engage the hydraulic pressure type engagement element (C-1) with a high responsiveness.

(6)

In the control device (90) according to any one of (1) to (5), after the ignition is turned on or the vehicular power supply is turned on, in a case in which the first change from the parking range to the travel range occurs, the control device causes the hydraulic pressure type engagement element (C-1) to transition to an engaged state through a slip state.

According to the configuration described in (6), it is possible to reduce a shock when the hydraulic pressure type engagement element (C-1) is engaged.

### DESCRIPTION OF THE REFERENCE NUMERALS

1/VEHICULAR DRIVE DEVICE
10/ENGINE
12/DAMPER
14/ENGINE DISCONNECTION CLUTCH
16/ELECTRIC MOTOR
20/TRANSMISSION
22/INPUT SHAFT
24/PLANETARY GEAR MECHANISM
26/RAVIGNEAUX TYPE GEAR MECHANISM
28/OUTPUT SHAFT
60/HYDRAULIC PRESSURE CIRCUIT
62/HYDRAULIC PRESSURE LINE
80/LINEAR SOLENOID
90/CONTROLLER

1. A control device for a vehicular drive device comprising a hydraulic pressure type engagement element that is provided between a drive source and drive wheels, the hydraulic pressure type engagement element being in a disengaged state when an ignition is turned on or a vehicular power supply is turned on and caused to transition to an engaged state when a parking range is changed to a travel range, wherein,
after the ignition is turned on or the vehicular power supply is turned on and before a first change from the parking range to the travel range occurs, the control device supplies oil to a piston hydraulic pressure chamber of the hydraulic pressure type engagement element in a manner such that air in the piston hydraulic pressure chamber of the hydraulic pressure type engagement element is discharged but a torque capacity does not exceed zero.

2. The control device according to claim 1, wherein,
after the oil has been supplied to the piston hydraulic pressure chamber and until the first change from the parking range to the travel range occurs, the control device repeats discharging the supplied oil from the piston hydraulic pressure chamber and supplying the oil to the piston hydraulic pressure chamber.

3. The control device according to claim 2, wherein,
a magnitude of a hydraulic pressure command value when the oil is supplied to the piston hydraulic pressure chamber is the same as a magnitude of an initial value of the hydraulic pressure command value when the first change from the parking range to the travel change has occurred.

4. The control device according to claim 1, wherein,
after the oil has been supplied to the piston hydraulic pressure chamber and until the first change from the parking range to the travel range occurs, the control device continues supplying the oil to the piston hydraulic pressure chamber.

5. The control device according to claim 4, wherein,
continuing supplying the oil to the piston hydraulic pressure chamber is executed in a manner such that a piston stroke after the oil has been supplied to the piston hydraulic pressure chamber is maintained.

6. The control device according to claim 1, wherein,
after the ignition is turned on or the vehicular power supply is turned on, in a case in which the first change from the parking range to the travel range occurs, the control device causes the hydraulic pressure type engagement element to transition to an engaged state through a slip state.

7. The control device according to claim 2, wherein,
after the ignition is turned on or the vehicular power supply is turned on, in a case in which the first change from the parking range to the travel range occurs, the control device causes the hydraulic pressure type engagement element to transition to an engaged state through a slip state.

8. The control device according to claim 3, wherein,
after the ignition is turned on or the vehicular power supply is turned on, in a case in which the first change from the parking range to the travel range occurs, the control device causes the hydraulic pressure type engagement element to transition to an engaged state through a slip state.

9. The control device according to claim 4, wherein,
after the ignition is turned on or the vehicular power supply is turned on, in a case in which the first change from the parking range to the travel range occurs, the control device causes the hydraulic pressure type engagement element to transition to an engaged state through a slip state.

10. The control device according to claim 5, wherein,
after the ignition is turned on or the vehicular power supply is turned on, in a case in which the first change from the parking range to the travel range occurs, the control device causes the hydraulic pressure type engagement element to transition to an engaged state through a slip state.
